(19) United States
(12) Patent Application Publication
(10) Pub. No.: US 2013/0149088 A1
(43) Pub. Date: Jun. 13, 2013

(54) Unloading Configuration for an Agricultural Grain Cart

(71) Applicant: AGCO Corporation, Duluth, GA (US)

(72) Inventors: Robert A. Matousek, Valley Center, KS (US); Aaron M. Loggan, Goessel, KS (US)

(73) Assignee: AGCO CORPORATION, Duluth, GA (US)

(21) Appl. No.: 13/711,720

(22) Filed: Dec. 12, 2012

Related U.S. Application Data
(60) Provisional application No. 61/569,625, filed on Dec. 12, 2011.

(51) Int. Cl. B60P 1/42

(52) U.S. Cl. CPC B60P 1/42
USPC 414/502

(57) ABSTRACT

A grain cart has a lower frame supported by an axle with a pair of wheels attached thereto and a grain storage hopper. The grain storage hopper includes a substantially vertical front wall, a substantially vertical rear wall, and left and right sidewalls. At least one trough extends along the bottom of the hopper and a sump is positioned below a central portion of the at least one trough, wherein the trough opens into the sump to permit the flow of grain from the trough into the sump. At least one horizontal auger, having a shaft and helical flighting, is rotatably secured in the at least one trough, wherein the flighting on one portion of the shaft is configured to move grain in a first direction toward the sump and the flighting on a second portion of the shaft is configured in a reverse orientation so as to move grain in an opposite direction toward the sump such that rotation of the shaft results in material at either end of the hopper moving toward the center of the hopper. The hopper also includes an unloading auger assembly extending from the sump to an upper corner of the hopper.

### CROSS REFERENCE TO RELATED APPLICATION

This application claims priority to U.S. Provisional Application No. 61/569,625 filed Dec. 12, 2011, entitled “UNLOADING CONFIGURATION FOR AN AGRICULTURAL GRAIN CART.”

### BACKGROUND OF THE INVENTION

1. Field of Invention

This invention relates to grain carts of the type used to transport and discharge harvested grain and other particulate agricultural products, and in particular grain carts incorporating a horizontal auger in combination with a discharge auger for unloading the cart.

2. Description of Related Art

Grain carts are typically used in combination with combines during the harvesting procedure to facilitate transfer of grain from the combines to trucks waiting outside of the fields being harvested. The combines can only store a limited amount of grain, typically about 200-400 bushels. Grain carts, depending on the type, can typically hold between 500 and 2000 bushels of grain. In use, grain carts can be pulled by a tractor, up along the side of an operating combine, such that the combine operator may discharge grain stored in the combine into the grain cart without having to stop harvesting eliminating combine downtime and maximizing combine use.

Grain carts incorporate a relatively large hopper for storing grain and a discharge auger assembly for discharging grain from the hopper. The discharge auger generally extends from the bottom of the hopper upward and beyond an upper edge of the hopper and away from the cart for discharging grain into a truck or other storage vessel.

Some grain carts rely solely on gravity to feed grain in the hopper to the discharge auger. The four side and end walls of the hoppers of such carts are sloped downwardly and inwardly in an inverted pyramid and converge at a sump. The lower or intake end of the discharge auger is positioned in the sump and carries the grain upward at some angle to the edge of the hopper. The requisite degree of sloping of the hopper side walls and end walls to ensure proper flow of grain to the discharge auger results in grain carts with a relatively high profile and high center of gravity. The high profile often presents difficulties in making sure that the discharge auger from combines or other carts will extend over the grain cart hopper walls. The high center of gravity of such carts presents disadvantages including poor handling and the potential for tipping.

Relatively low profile grain carts have been developed which incorporate a horizontally extending horizontal auger for feeding grain to the discharge auger. In such carts, the sidewalls converge to form a trough extending centrally and longitudinally along the bottom of the hopper. Grain or other particulate materials feed into the trough by gravity. The horizontal auger is secured in the trough and advances or drags the material forward to a sump below the horizontal auger at one end of the hopper. The lower end of the discharge auger extends into the sump.

The need exists for an improved grain cart for the reliable transport and discharge of grain and other agricultural products. Such an improved cart should have a relatively low profile while providing simple yet efficient means for unloading the cart.

### Overview of the Invention

In one embodiment, the invention relates to a grain cart having a lower frame supported by an axle with a pair of wheels attached thereto and a grain storage hopper. The grain storage hopper includes a substantially vertical front wall, a substantially vertical rear wall, and left and right sidewalls. At least one trough extends along the bottom of the hopper and a sump is positioned below a central portion of the at least one trough, wherein the trough opens into the sump to permit the flow of grain from the trough into the sump. At least one horizontal auger, having a shaft and helical flighting, is rotatably secured in the at least one trough, wherein the flighting on one portion of the shaft is configured to move grain in a first direction toward the sump and the flighting on a second portion of the shaft is configured in a reverse orientation so as to move grain in an opposite direction toward the sump such that rotation of the shaft results in material at either end of the hopper moving toward the center of the hopper. The hopper also includes an unloading auger assembly extending from the sump to an upper corner of the hopper.

In one embodiment, the hopper has one trough generally perpendicular with the axle and between a lower edge of the rear sidewall and a lower edge of the front sidewall. In another embodiment, the hopper includes a bottom platform extending between the front and rear walls and the left and right sidewalls and the bottom platform forms a central ridge with inclined sections sloping away from the central ridge such that the bottom of the hopper has a generally W-shape forming a pair of troughs extending longitudinally along the bottom of the hopper generally perpendicular with the axle, and wherein each trough contains a horizontal auger. In another embodiment, the bottom platform has a central ridge running parallel with the axle with inclined sections sloping away from the central ridge, the inclined sections meeting with the front and rear walls and forming a first trough near the front wall and a second trough near the rear wall extending laterally across the bottom of the hopper generally parallel with the axle. The hopper has a third lower trough under and perpendicular to the first and second troughs with the first and second troughs opening into the third lower trough through trough openings in the bottom platform, and wherein the sump is positioned below a central portion of the third lower trough. In another embodiment, the bottom platform forms a pair of diagonal and intersecting troughs and the sump is positioned below the intersection of the two troughs.

These and other features and advantages of this invention are described in, or are apparent from, the following detailed description of various example embodiments of the systems and methods according to this invention.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 is a schematic end view of an embodiment of a grain cart;

FIG. 2 is a schematic side view of the grain cart of FIG. 1;

FIG. 3 is a schematic plan view of the grain cart of FIG. 1;

FIG. 4 is a schematic end view of another embodiment of a grain cart;

FIG. 5 is a schematic side view of the grain cart of FIG. 4;

FIG. 6 is a schematic plan view of the grain cart of FIG. 4;

FIG. 7 is a schematic end view of another embodiment of a grain cart;

FIG. 8 is a schematic side view of the grain cart of FIG. 7;

FIG. 9 is a schematic plan view of the grain cart of FIG. 7;

FIG. 10 is a schematic end view of another embodiment of a grain cart;

FIG. 11 is a schematic side view of the grain cart of FIG. 10; and

FIG. 12 is a schematic plan view of the grain cart of FIG. 10.

Corresponding reference characters indicate corresponding parts throughout the views of the drawings.

### DESCRIPTION OF EXAMPLE EMBODIMENTS

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

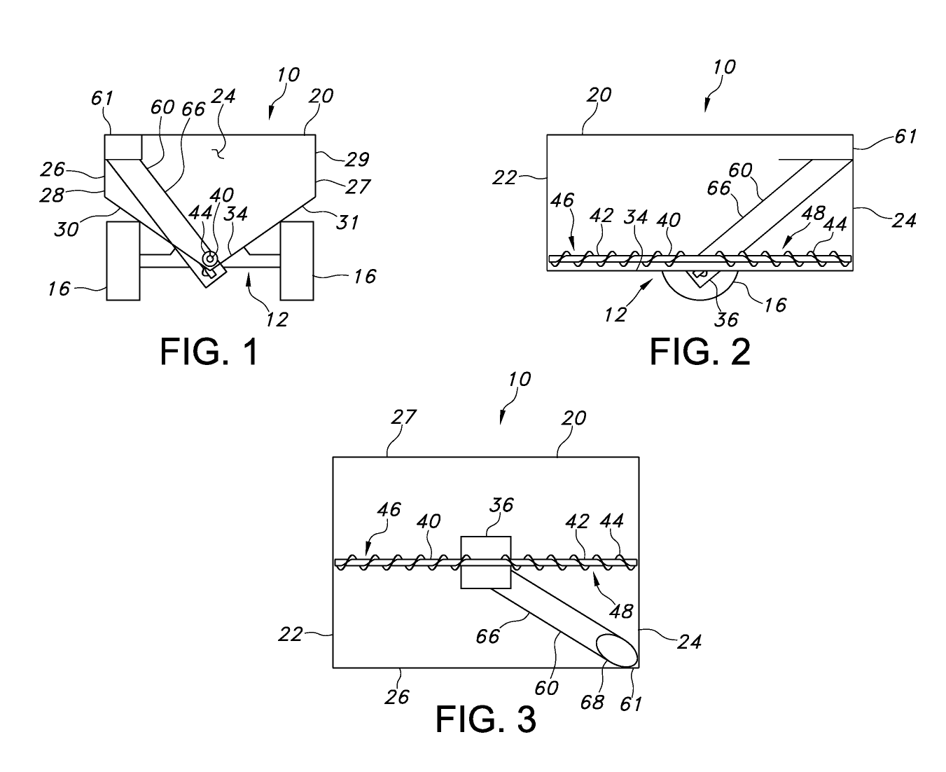

Referring to the drawings in more detail, reference numeral 10 in FIGS. 1-3 generally designates a grain cart in accordance with one embodiment of invention. The cart 10 comprises a lower frame 12 supported by an axle 14 with a pair of wheels 16 attached thereto. The cart 10 is adapted to be secured to a tow vehicle such as a tractor (not shown) via a tongue (not shown) as is customary in the art.

A grain storage hopper, generally indicated as 20, is supported by the lower frame 12 by any known means using sound engineering judgment. The hopper comprises a front wall 22, a rear wall 24, and left and right sidewalls 26, 27. Desirably, the front and rear walls 22, 24 are substantially vertical to maximize the grain holding capacity of the hopper 20. The left and right sidewalls 26, 27 have substantially vertical upper portions 28, 29. Extending downward from the upper portions 28, 29, the left and right sidewalls 26, 27 have lower incline portions 30, 31. The lower incline portions 30, 31 of the left and right sidewalls 26, 27 incline inward and downward in a general V-shape to converge at a trough 34. The trough 34 extends longitudinally along the bottom of the hopper 20 generally perpendicular with the axle 14 between a lower edge of the rear sidewall 24 and a lower edge of the front sidewall 22. A sump 36 is positioned below a central portion of the bottom of the trough 34. The trough 34 opens into the sump 36.

A horizontal auger 40, incorporating a shaft 42 and helical flighting 44 is rotatably secured in the trough 34. The flighting 44 on a forward portion 46 of the shaft 42 is configured to move grain rearward toward the sump 36 and the flighting 44 on a rearward portion 48 of the shaft 42 is configured in an opposite or reverse orientation to move grain forward toward the sump 36 such that common rotation of the shaft 42 results in material at either end of the hopper 20 moving to the center of the hopper 20. It is foreseen that drive means (not shown) for rotatably driving the horizontal auger 40 may comprise a wide range of drive mechanisms including a hydraulic motor connected to a hydraulic pump on the tractor or comparable tow vehicle. In one embodiment, the portion of the shaft 42 extends through and is rotatably supported by a suitable bearing in front wall 22 and the auger shaft 42 is connected to the tractor power-take off via conventional gear box and drive shaft assembly (not shown).

The cart 10 also includes an unloading auger assembly 60 which extends from the sump 36 upward through the hopper 20 toward an upper corner 61 of the hopper 20. As is known in the art, the unloading auger assembly 60 includes an auger shaft 62 and helical flights 64 that rotate in an unloading tube 66. In the illustrated embodiment, a discharge end 68 of the unloading auger assembly 60 is positioned at a confluence between the rear wall 24 and the left sidewall 26. However, one skilled in the art will understand that the unloading discharge end 68 of the unloading auger assembly 60 may be positioned at any of the upper corners 61 of the hopper 20.

Each end of the horizontal auger 40 moves grain along the trough 34 toward the central portion of the hopper such that the grain falls or is otherwise directed into the sump 36 which is located below the central portion of the horizontal auger 40. Grain entering in the sump 36 is then fed out of the hopper 20 via the unloading auger assembly 60. As the horizontal auger 40 advances grain along the trough 34, additional grain flows by gravity into the trough 34 and is then advanced to the sump 36.

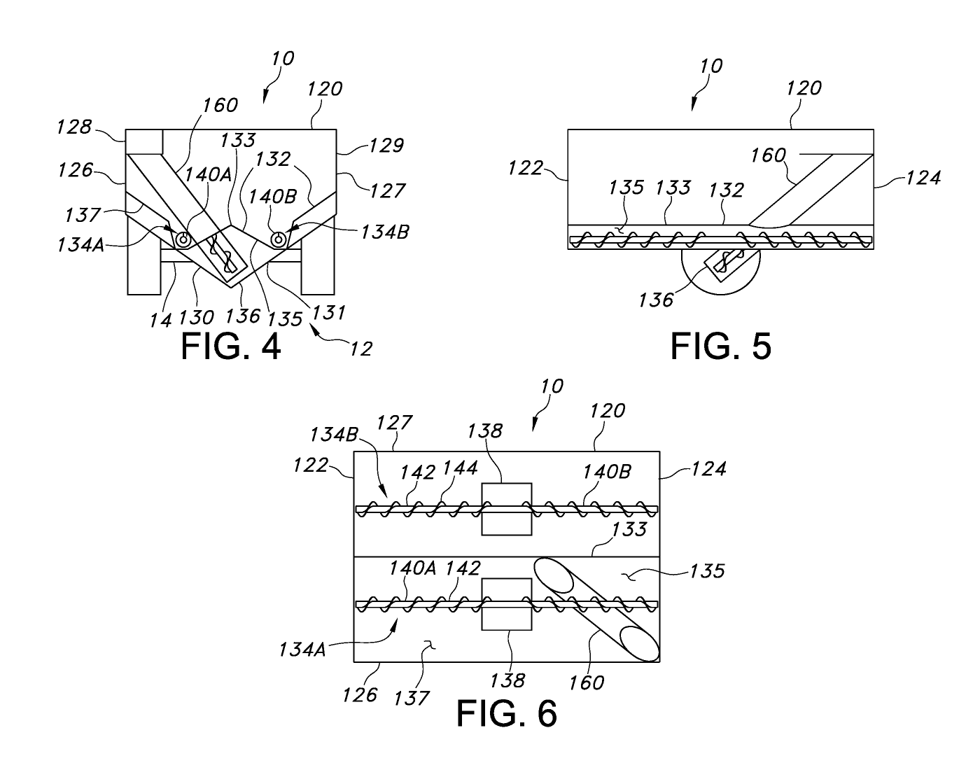

FIGS. 4 through 6 illustrate a second embodiment of a hopper 120 supported by the lower frame 12 of the cart 10. The hopper 120 comprises a front wall 122, a rear wall 124, and left and right sidewalls 126, 127. The left and right sidewalls 126, 127 have substantially vertical upper portions 128, 129. Extending downward from the upper portions 128, 129, the left and right sidewalls 126, 127 have lower incline portions 130, 131. The lower incline portions 130, 131 of the left and right sidewalls 126, 127 incline inward and downward in a general V-shape. The hopper 120 also has a bottom platform 132 extending between the front and rear walls 122, 124 and the left and right sidewalls 126, 127. The bottom platform 132 has a central ridge 133 with inclined sections 135 sloping away from the central ridge 133. The inclined sections 135 meet with the left and right sidewalls 126, 127 or with outer upward sloping sections 137 such that the bottom of the hopper 120 has a generally W-shape as best seen in FIG. 4. The inclined sections 135 form a pair of troughs 134A and 134B extending longitudinally along the bottom of the hopper 120 generally perpendicular with the axle 14 between a lower edge of the rear sidewall 124 and a lower edge of the front sidewall 122. A sump 136 is positioned below a central portion of the bottom of the two troughs 134A, 134B. The troughs 134A, 134B open into the sump 136 through sump openings 138 in the bottom platform 132.

Each trough 134A, 134B contains a horizontal auger 140A, 140B, respectively, rotatably secured in the trough 134A, 134B. Each auger 140A, 140B has a shaft 142 and helical flighting 144. The flighting 144 on a forward portion of the shaft 142 is configured to move grain rearward toward the sump 136 and the flighting 144 on a rearward portion of the shaft 142 is configured in an opposite direction to move grain forward toward the sump 136 such that common rotation of the shaft 142 results in material moving to the center of the hopper 120. It is foreseen that drive means for rotatably driving the horizontal augers 140A, 140B may comprise a wide range of drive mechanisms supported by the tractor or comparable tow vehicle.

An unloading auger assembly 160 which extends from the sump 136 upward through the upper hopper portion 122 toward an upper corner of the hopper 120 as described above. The horizontal augers 140A, 140B move grain along the troughs 134A, 134B such that the grain falls or is otherwise directed into the sump 136 where it is then fed out of the hopper 120 via the unloading auger assembly 160. As the horizontal auger 140A, 140B advances grain along the trough 134A, 134B, additional grain flows by gravity into the trough 134A, 134B and is then advanced to the sump 136.

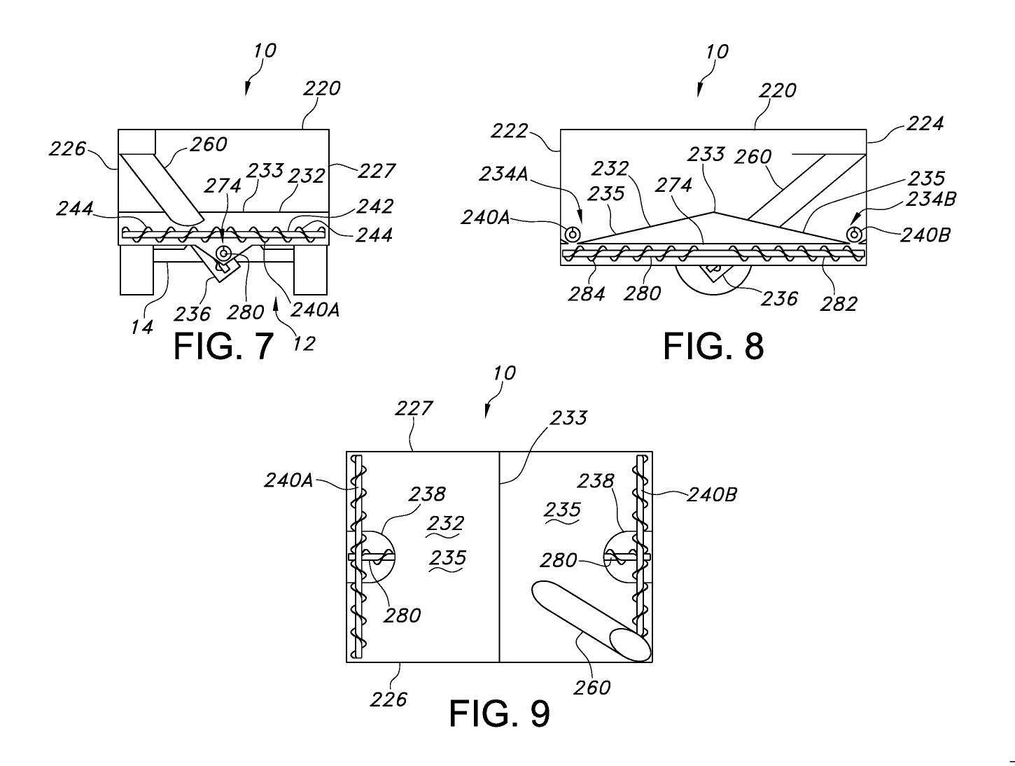

FIGS. 7 through 9 illustrate a third embodiment of a hopper 220 supported by the lower frame 12 of the cart 10. The hopper 220 comprises a front wall 222, a rear wall 224, and left and right sidewalls 226, 227. The left and right sidewalls 226, 227 desirably are substantially vertical to maximize the grain holding capacity of the hopper 220. The hopper 220 also has a bottom platform 232 extending between the front and rear walls 222, 224 and the left and right sidewalls 226, 227. The bottom platform 232 has a central ridge 233 running parallel with the axle 14 with inclined sections 235 sloping away from the central ridge 233. The inclined sections 235 meet with the front and rear walls 222, 224 such that the bottom of the hopper 120 has a generally W-shape when viewed from the side as best seen in FIG. 8. The inclined sections 235 form a pair of troughs 234A and 234B, one trough 234A near the front wall 222 and one trough 234B near the rear wall 224, extending laterally across the bottom of the hopper 220 generally parallel with the axle 14 between a lower edge of the left sidewall 226 and a lower edge of the right sidewall 227. A lower trough 274 is positioned under the troughs 234A, 234B running between central portions of the two troughs 234A, 234B. The troughs 234A, 234B open into the lower trough 274 through trough openings 238 in the bottom platform 232. A sump 236 is positioned below a central portion of the bottom of the lower trough 274. The lower trough 274 opens into the sump 236.

Each trough 234A, 234B contains a horizontal auger 240A, 240B, respectively, rotatably secured in the troughs 234A, 234B. Each auger 240A, 240B has a shaft 242 and helical flighting 244. The flighting 244 on each side of the shaft 242 is configured to move grain inward toward the trough opening 238 and the lower trough 274 such that common rotation of the shaft 242 results in material moving to the center of the hopper 220.

The lower trough 274 extends longitudinally along the bottom of the hopper 220 generally perpendicular with the axle 14 between a lower edge of the rear sidewall 224 and a lower edge of the front sidewall 222. A third horizontal auger 280, incorporating a shaft 282 and helical flighting 284 is rotatably secured in the sump 236. The flighting 284 on a forward portion of the shaft 282 is configured to move grain rearward toward the sump 276 and the flighting 284 on a rearward portion of the shaft 282 is configured in an opposite direction to move grain forward toward the sump 276 such that common rotation of the shaft 282 results in material moving to the center of the hopper 220. It is foreseen that drive means for rotatably driving the horizontal augers 240A, 240B, 280 may comprise a wide range of drive mechanisms supported by the tractor or comparable tow vehicle as set forth above.

An unloading auger assembly 260 which extends from the sump 236 upward through the upper hopper portion 222 toward an upper corner of the hopper 220 as described above. The horizontal augers 240A, 240B move grain along the troughs 234A, 234B such that the grain falls or is otherwise directed into the lower trough 274. The horizontal auger 280 moves the grain along the lower trough 274 and into the sump 236 where it is then fed out of the hopper 220 via the unloading auger assembly 260. As the horizontal auger 240A, 240B advances grain along the trough 234A, 234B and into the lower trough 274, additional grain flows by gravity into the troughs 234A, 234B.

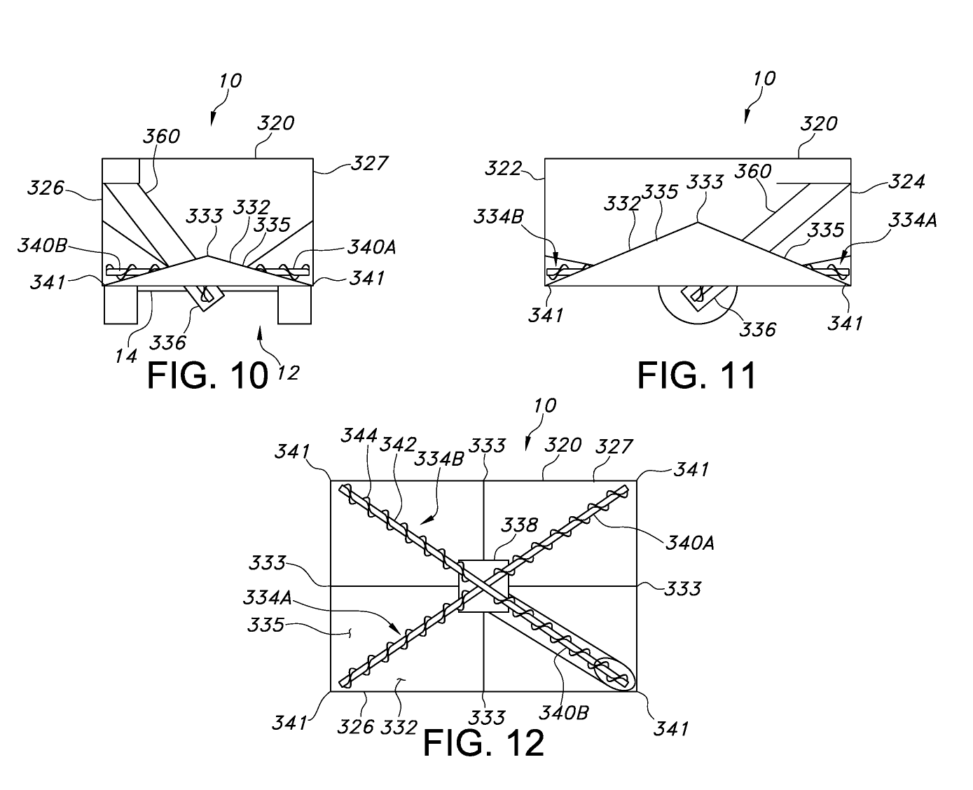

FIGS. 10 through 12 illustrate a fourth embodiment of the cart 10 having a hopper 320 supported by the lower frame 12. The hopper 320 comprises a front wall 322, a rear wall 324, and left and right sidewalls 326, 327. The left and right sidewalls 326, 327 have substantially vertical upper portions 328, 329. The hopper 320 also has a bottom platform 332 extending between the front and rear walls 322, 324 and the left and right sidewalls 326, 327. The bottom platform 332 has peaks 333 adjacent the middle of the front wall 322, the rear wall 324, and the left and right sidewalls 326, 327 with inclined sections 335 sloping away from the peaks 333. The inclined sections 335 meet such that the bottom of the hopper 320 forms a pair of diagonal and intersecting troughs 334A and 334B between the four bottom corners 341 of the hopper 320. A sump 336 is positioned below the intersection of the two troughs 334A, 334B. The troughs 334A, 334B open into the sump 336 through a sump opening 338 in the bottom platform 332.

Each trough 334A, 334B contains a horizontal auger 340A, 340B, respectively, rotatably secured in the trough 334A, 334B. Each auger 340A, 340B has a shaft 342 and helical flighting 344. The flighting 344 on the shaft 342 is configured to move grain inward toward the sump 336 such that common rotation of the shaft 342 results in material moving to the center of the hopper 320. It is foreseen that drive means for rotatably driving the horizontal augers 340A, 340B may comprise a wide range of drive mechanisms supported by the tractor or comparable tow vehicle.

An unloading auger assembly 360 which extends from the sump 336 upward through the upper hopper portion 322 toward an upper corner of the hopper 320 as described above. The horizontal augers 340A, 340B move grain along the troughs 334A, 334B such that the grain falls or is otherwise directed into the sump 336 where it is then fed out of the hopper 320 via the unloading auger assembly 360. As the horizontal auger 340A, 340B advances grain along the trough 334A, 334B, additional grain flows by gravity into the trough 334A, 334B and is then advanced to the sump 336.

While this invention has been described in conjunction with the specific embodiments described above, it is evident that many alternatives, combinations, modifications and variations are apparent to those skilled in the art. Accordingly, the preferred embodiments of this invention, as set forth above are intended to be illustrative only, and not in a limiting sense. Various changes can be made without departing from the spirit and scope of this invention.

What is claimed is:

1. A grain cart having a lower frame supported by an axle with a pair of wheels attached thereto and a grain storage hopper, the grain storage hopper comprising:
a substantially vertical front wall;
a substantially vertical rear wall;
left and right sidewalls;
at least one trough extending along the bottom of the hopper;
a sump positioned below a central portion of the at least one trough, wherein the trough opens into the sump to permit the flow of grain from the trough into the sump;
at least one horizontal auger, comprising a shaft and helical flighting, rotatably secured in the at least one trough, wherein the flighting on one portion of the shaft is configured to move grain in a first direction toward the sump and the flighting on a second portion of the shaft is configured in a reverse orientation so as to move grain in an opposite direction toward the sump such that rotation of the shaft results in material at either end of the hopper moving toward the center of the hopper; and
an unloading auger assembly extending from the sump to an upper corner of the hopper.

2. The grain cart of claim 1 wherein the trough is generally perpendicular with the axle between a lower edge of the rear sidewall and a lower edge of the front sidewall.

3. The grain cart of claim 1 wherein each end of the at least one horizontal auger moves grain along the at least one trough toward the central portion of the hopper such that the grain falls or is otherwise directed into the sump located below a central portion of the horizontal auger such that as the horizontal auger advances grain along the trough, additional grain flows by gravity into the trough and is then advanced to the sump.

4. The grain cart of claim 1 wherein the hopper further comprises a bottom platform extending between the front and rear walls and the left and right sidewalls.

5. The grain cart of claim 4 wherein the bottom platform has a central ridge with inclined sections sloping away from the central ridge such that the bottom of the hopper has a generally W-shape forming a pair of troughs extending longitudinally along the bottom of the hopper generally perpendicular with the axle, and wherein each trough contains a horizontal auger.

6. The grain cart of claim 4 wherein the bottom platform has a central ridge running parallel with the axle with inclined sections sloping away from the central ridge, said inclined sections meeting with the front and rear walls and forming a first trough near the front wall and a second trough near the rear wall extending laterally across the bottom of the hopper generally parallel with the axle, wherein the hopper comprises a third lower trough under and perpendicular to the first and second troughs with the first and second troughs opening into the third lower trough through trough openings in the bottom platform, and wherein the sump is positioned below a central portion of the third lower trough.

7. The grain cart of claim 6 wherein the first, second and third troughs each contain a horizontal auger.

8. The grain cart of claim 4 wherein the bottom platform forms a pair of diagonal and intersecting troughs and the sump is positioned below the intersection of the two troughs.
